(19) United States
(12) Patent Application Publication
(10) Pub. No.: US 2025/0143950 A1
(43) Pub. Date: May 8, 2025

(54) REHABILITATION DEVICE

(71) Applicant: KAO CHEN ENTERPRISE CO., LTD., TAICHUNG CITY (TW)

(72) Inventors: Yu-Sheng YANG, TAICHUNG CITY (TW); Li-Chi CHAO, TAICHUNG CITY (TW)

(21) Appl. No.: 19/012,108

(22) Filed: Jan. 7, 2025

Related U.S. Application Data
(63) Continuation-in-part of application No. 17/371,722, filed on Jul. 9, 2021.

(51) Int. Cl. A61H 1/02

(52) U.S. Cl. CPC A61H 1/0288; A61H 2201/1215; A61H 2201/149; A61H 2201/1638; A61H 2201/165; A61H 2201/1676

(57) ABSTRACT

A rehabilitation device is provided, including abase, a finger sleeve assembly and a thumb sleeve assembly. The finger sleeve assembly includes a finger frame rotatably connected to the base and including first linkage slots, first linkage mechanisms disposed within the first linkage slots, and a first actuator rotatably connected to the base and a first actuator slot of the finger frame and configured to drive the finger frame so that the first linkage mechanisms are swingable with the finger frame. The thumb sleeve assembly includes a thumb frame rotatably connected to the base and including a second actuator slot, a second linkage mechanism disposed within the second actuator slot, and a second actuator rotatably connected to the base and a second actuator slot of the thumb frame and configured to drive the thumb so that the second linkage mechanism is swingable with the thumb frame.

### BACKGROUND OF THE INVENTION

The present invention is a CIP of application Ser. No. 17/371,722, filed Jul. 9, 2021, the entire contents of which are hereby incorporated by reference.

### FIELD OF THE INVENTION

### Description of the Prior Art

Cerebrovascular disease can cause functional dysfunction on the limbs, which will seriously affect the quality of life of the patient. For example, the abnormal tension of the hand muscles causes the fingers to curl and the fingers are clenched to hold a fist, and therefore the palm is hard to open, which makes the palm sultry, wet and sticky, causing a lot of effort and trouble to clean or trim nails or to change clothes. There are known rehabilitation devices for fingers, such as TW M583754, TW M586120, TW I620558, TW I620559, TW I691326 and TW I715251.

The device disclosed in TW 1620558 is provided with complicated mechanisms for finger and thumb so that the production time and cost are quite high, and each mechanism needs to be equipped with a linear direct drive motor so that the overall weight is quite high and it is quite troublesome and inconvenient to wear.

The present invention is, therefore, arisen to obviate or at least mitigate the above-mentioned disadvantages.

### SUMMARY OF THE INVENTION

The main object of the present invention is to provide a rehabilitation device which can be used for rehabilitation of bending and straightening of fingers and thumb, has a simple structure and overall weight, and is convenient to operate and wear.

To achieve the above and other objects, a rehabilitation device is provided, including a base, a finger sleeve assembly and a thumb sleeve assembly; wherein the finger sleeve assembly includes a finger frame, a plurality of first linkage mechanisms and a first actuator, the finger frame is rotatably connected to the base by two first ear portions, the finger frame includes a plurality of first linkage slots within which the plurality of first linkage mechanisms are respectively disposed, two ends of the first actuator are rotatably connected respectively to the base and a first actuator slot of the finger frame, the first actuator is movable between an extended position and a retracted position to drive the finger frame to rotate between a lower swing position and an upper swing position relative to the base so that the plurality of first linkage mechanisms are swingable with the finger frame; wherein the thumb sleeve assembly includes a thumb frame, a second linkage mechanism and a second actuator, the thumb frame is rotatably connected to the base by two second ear portions, the thumb frame includes a second linkage slot within which the second linkage mechanism is disposed, two ends of the second actuator are rotatably connected respectively to the base and a second actuator slot of the thumb frame, the second actuator is movable between an extended position and a retracted position to drive the thumb frame to rotate between an inward swing position and an outward swing position relative to the base so that the second linkage mechanism is swingable with the thumb frame.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of a preferable embodiment of the present invention;

FIGS. 3 and 4 are drawings showing operation of a finger sleeve assembly of a preferable embodiment of the present invention;

FIGS. 5 and 6 are drawings showing operation of a thumb sleeve assembly of a preferable embodiment of the present invention;

FIG. 7 is a breakdown drawing showing a finger frame, a first linkage mechanism and a first actuator according to a preferable embodiment of the present invention;

FIG. 8 is a breakdown drawing showing the first linkage mechanism of a preferable embodiment of the present invention;

FIG. 9 is a breakdown drawing showing a first rope, a first bolt, a first stopper of the first linkage mechanism according to a preferable embodiment of the present invention;

FIG. 10 is a breakdown drawing showing a thumb frame, a second linkage mechanism and a second actuator according to a preferable embodiment of the present invention;

FIG. 11 is a breakdown drawing showing the second linkage mechanism of a preferable embodiment of the present invention;

FIG. 12 is a breakdown drawing showing a second rope, a second bolt and a second stopper of the second linkage mechanism according to a preferable embodiment of the present invention;

FIG. 13 is a drawing showing an external control device electrically connected with the second actuator and the first actuator according to a preferable embodiment of the present invention;

FIG. 14 is a drawing showing a first cover, a second cover and a fastening strap attached to the rehabilitation device according to a preferable embodiment of the present invention;

FIG. 15 is a drawing showing adjustment of the first linkage mechanism toward an upper swing position according to a preferable embodiment of the present invention; and

FIG. 16 is a drawing showing adjustment of the second linkage mechanism toward an upper swing position according to a preferable embodiment of the present invention.

### DETAILED DESCRIPTION OF THE PREFERRED EMBODIMENTS

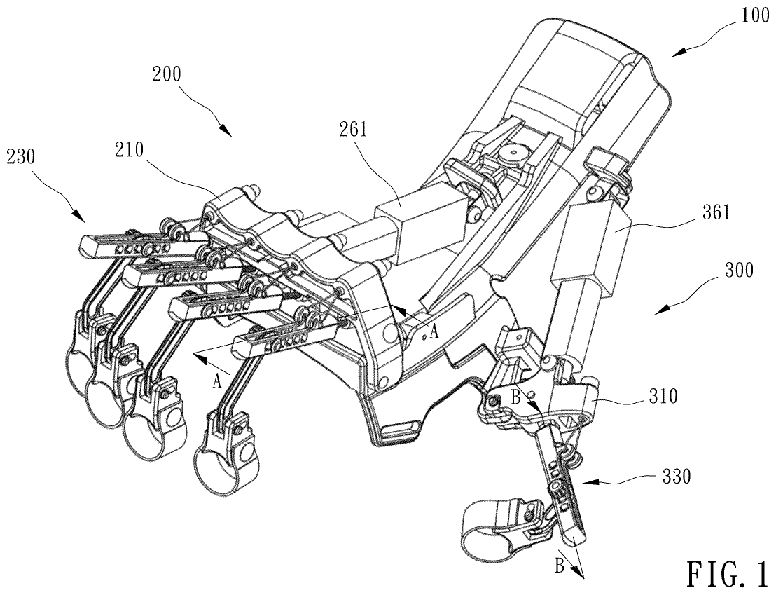

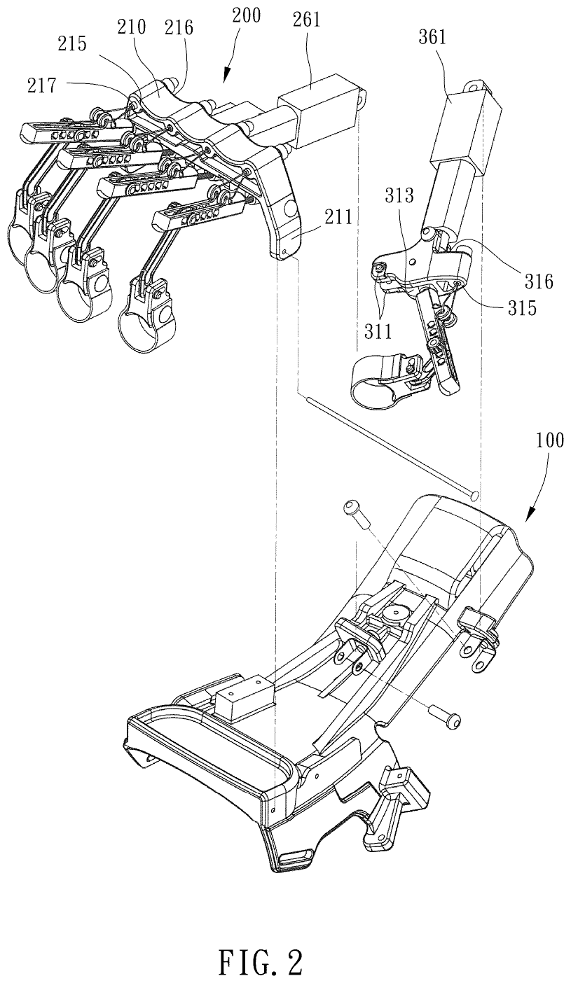

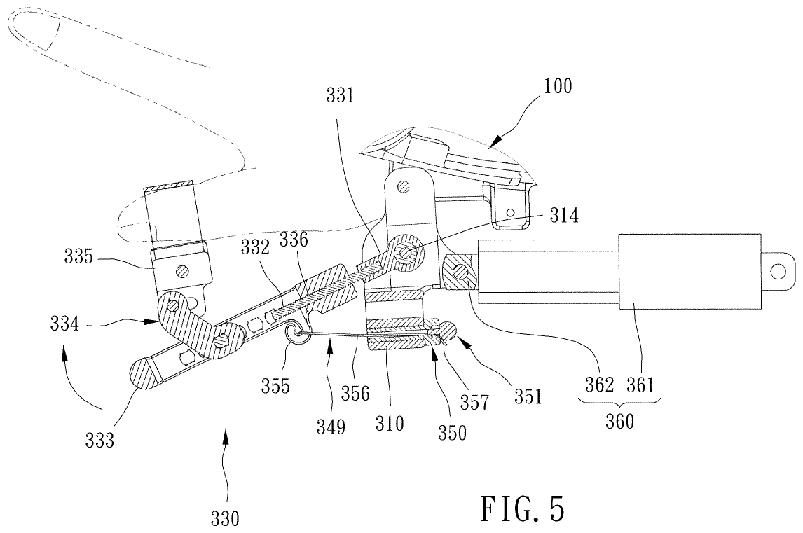

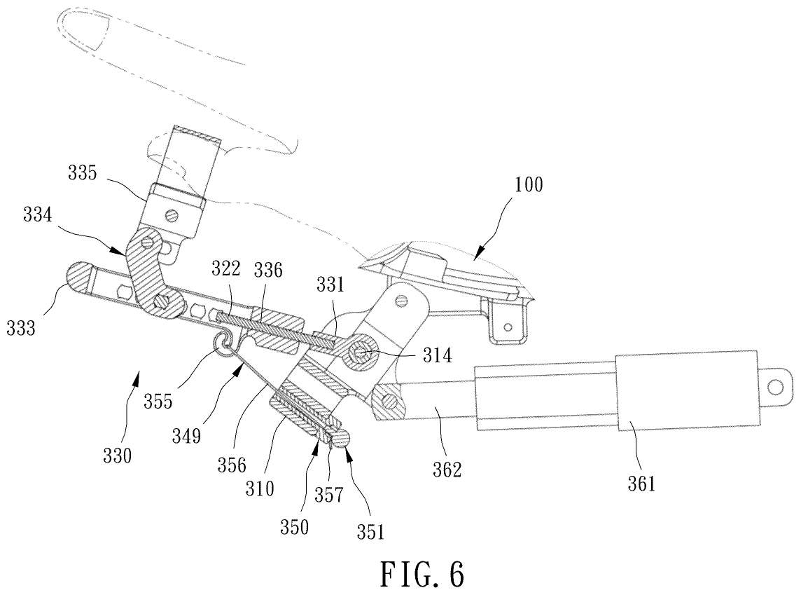

Please refer to FIGS. 1 to 6 for a preferable embodiment of the present invention. A rehabilitation device 1 of the present invention includes a base 100, a finger sleeve assembly 200 and a thumb sleeve assembly 300.

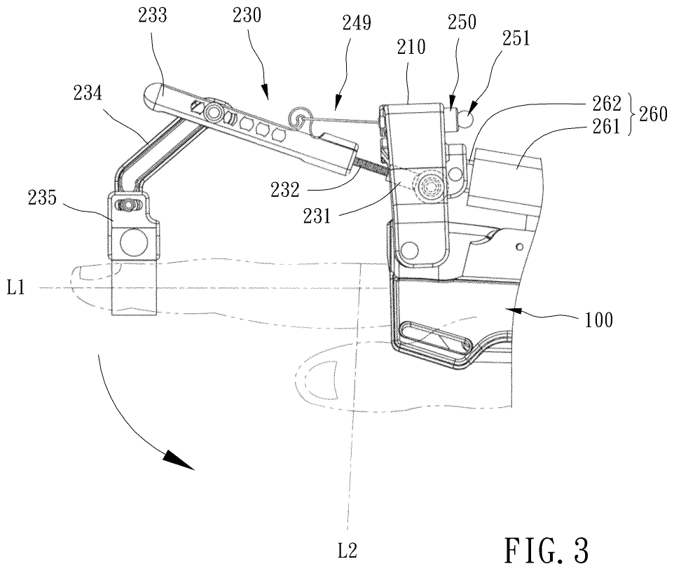

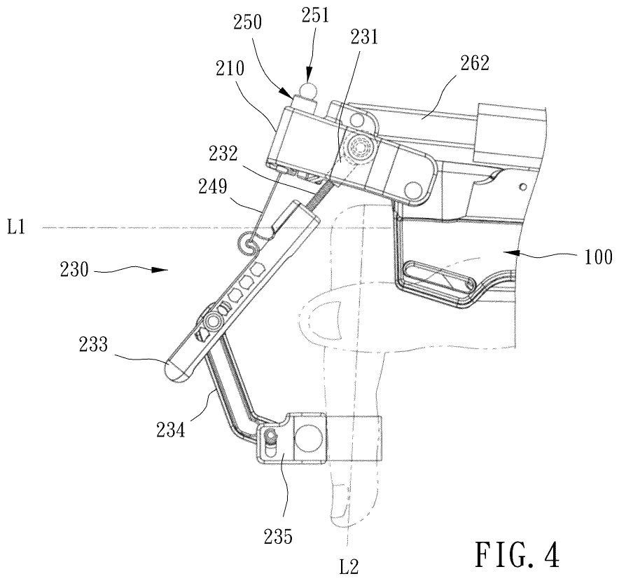

The finger sleeve assembly 200 includes a finger frame 210, a plurality of first linkage mechanisms 230 and a first actuator 260, the first actuator 260 includes a first motor 261 and a first driving shaft 262, the first driving shaft 262 is connected to the first motor 261, the first motor 261 is configured to drive the first driving shaft 262 to move axially relative to the first motor 261; the finger frame 210 is rotatably connected to the base 100 by two first ear portions 211, the finger frame 210 includes a plurality of first linkage slots 212 within which the plurality of first linkage mechanisms 230 are respectively disposed, the first motor 261 is rotatably connected to the base 100, the first driving shaft 262 is rotatably connected to a first actuator slot 213 of the finger frame 210, and the first actuator 260 is movable between an extended position and a retracted position to drive the finger frame 210 to rotate between a lower swing position and an upper swing position relative to the base 100 (as shown in FIGS. 3-4) so that the plurality of first linkage mechanisms 230 are swingable with the finger frame 210. The first linkage mechanisms 230 includes four first linkage mechanisms, for example, configured to being worn on index finger, middle finger, ring finger and little finger, respectively, for muscle rehabilitation. FIGS. 3-4 show one of the first linkage mechanisms 230 for explanation, in which the finger may be straightened to be along an axis L1 (FIG. 3), or the finger may be bent to be along an axis L2 (FIG. 4).

The thumb sleeve assembly 300 includes a thumb frame 310, a second linkage mechanism 330 and a second actuator 360, the second actuator 360 includes a second motor 361 and a second driving shaft 362, the second driving shaft 362 is connected to the second motor 361, the second motor 361 is configured to drive the second driving shaft 362 to move axially relative to the second motor 361; the thumb frame 310 is rotatably connected to the base 100 by two second ear portions 311, the thumb frame 310 includes a second linkage slot 312 within which the second linkage mechanism 330 is disposed, the second motor 361 is rotatably connected to the base 100, the second driving shaft 362 is rotatably connected to a second actuator slot 313 of the thumb frame 310, and the second actuator 360 is movable between an extended position and a retracted position to drive the thumb frame 310 between an inward swing position and an outward swing position relative to the base 100 so that the second linkage mechanism 330 is swingable with the thumb frame 310. The second linkage mechanism 330 is configured to being worn on a thumb, for muscle rehabilitation.

Through movement of the first actuator 260 and the second actuator 360 between the extended position and the retracted position, the finger frame 210 and the thumb frame 310 can be driven to swing reciprocally relative to base 100, and the first linkage mechanism 230 and the second linkage mechanism 330 respectively move with the finger frame 210 and the thumb frame 310 so that the index finger, middle finger, ring finger, little finger and thumb can be straightened and bent reciprocally, which lower tension of muscle.

Through the finger frame 210 rotatably connected to base 100, it requires only one said first actuator 260 to drive the finger frame 210 to swing relative to the base 100, and the plurality of first linkage mechanisms 230 are movable with the finger frame 210. Compared to the conventional device which includes a plurality of linear direct drive motors for driving respective linkage mechanisms, it is simple in structure and can reduce overall weight.

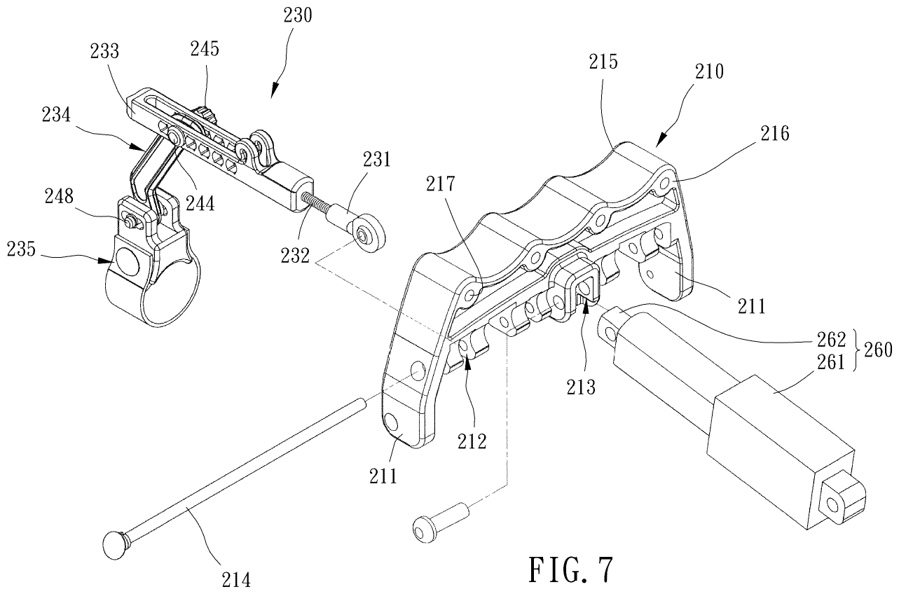

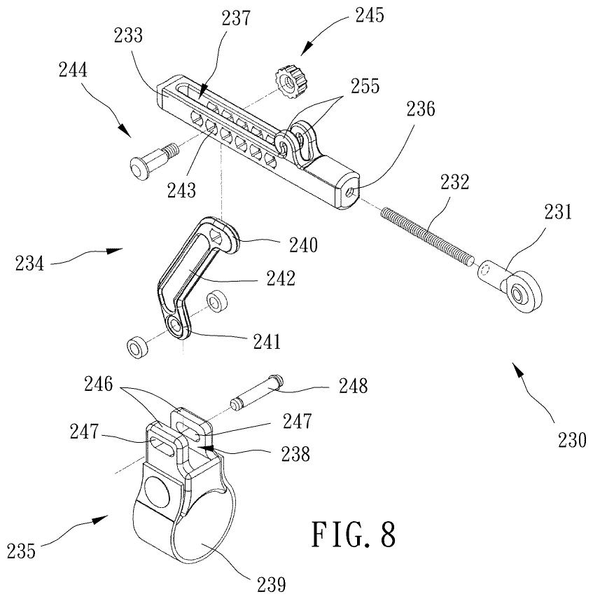

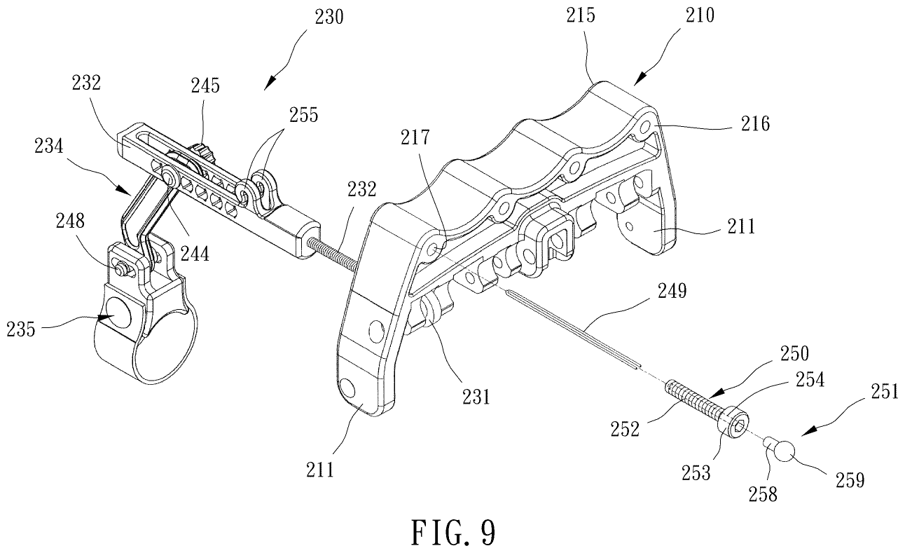

Please refer to FIGS. 7-9 and 15, each of the plurality of first linkage mechanisms 230 includes a first joint support 231, a first threaded rod 232, a first rear rod 233, a first fore rod 234 and a first sleeving member 235. Two ends of the first threaded rod 232 are respectively screwed with the first joint support 231 and a first threaded hole 236 of the first rear rod 233, which provides adjustment of distance between the first rear rod 233 and the first joint support 231, and this make it suitable for fingers of different individuals.

Two ends of the first fore rod 234 are movably connected respectively with a first rear elongated slot 237 of the first rear rod 233 and a first assembling slot 238 of the first sleeving member 235. The first sleeving member 235 includes a first strap 239, and the first strap 239 is preferably an elastic band which is easy and comfortable in use. Each of the plurality of first linkage mechanisms 230 is rotatably connected with a first shaft 214 by the first joint support 231 so as to be located within one of the plurality of first linkage slots 212, which provides a limited lateral swinging range for obtaining lateral adjustment of the first linkage mechanism 230 after wearing, and thus it provides additional lateral rehabilitation movement of the fingers.

In addition, the first fore rod 234 includes a first upper bent section 240, a first lower bent section 241 and a first middle section 242, and two ends of the first middle section 242 are integrally connected with the first upper bent section 240 and the first lower bent section 241. The first upper bent section 240 and the first lower bent section 241 extend in different directions. The first rear rod 233 includes a plurality of first adjustment holes 243 arranged along the first rear elongated slot 237 and through the first rear elongated slot 237, a first upper shaft 244 is movably disposed through the first upper bent section 240 and one of the plurality of first adjustment holes 243, and the first upper shaft is secured to the first rear rod 233 by a first securing member 245 so that the first fore rod 234 is stably secured and does not rotate itself relative to the first rear rod 233. The first sleeving member 235 includes two first projections 246, the first assembling slot 238 is located between the two first projections 246, each of the two first projections 246 includes a first sliding groove 247, a first lower shaft 248 is movably disposed through the first sliding groove 247 and the first lower bent section 241 so that the first sleeving member 235 is movable with the first lower shaft 248 being movable along the first sliding groove 247.

The first adjustment hole 243 is non-circular for non-rotatable insertion of the first upper shaft 244 and the first adjustment holes 243 are arranged along the first rear elongated slot 237 so that the insertion position of the first upper shaft 244 can be adjusted according to different finger lengths. By cooperation of the first sliding groove 247 and the first lower shaft 248, during operation, the first sleeving member 235 can move because the first lower shaft 248 is movable within the first sliding groove 247.

The finger frame 210 further includes a first outer side 215 and a first inner side 216 opposite to the first outer side 215, the finger frame 210 includes a plurality of finger frame threaded holes 217 respectively corresponding to the plurality of first linkage mechanisms 230, and the plurality of finger frame threaded holes 217 are disposed through the first outer side 215 and the first inner side 216. Each of the plurality of first linkage mechanisms 230 further includes a first rope 249, a first bolt 250 and a first stopper 251. The first bolt 250 includes a first rotation section 252 and a first driving section 253, the first bolt 250 further includes a first through hole 254 disposed through the first rotation section 252 and the first driving section 253, the first bolt 250 is screwed with the finger frame threaded hole 217 by the first rotation section 252, and the first driving section 253 is protrusive beyond the finger frame threaded hole 217 and located at the first inner side 216. A portion of the first rope 249 which is disposed through the first through hole 254 and hooked within at least one first hook portion 255 of the first rear rod 233 is defined as a first tension section 256, and another portion of the first rope 249 which is protrusive beyond the first through hole 254 is defined as a first free section 257. A first plug portion 258 of the first stopper 251 urges the first rope 249 and blocks the first rope 249 from detaching from the first through hole 254, and a first enlarged portion 259 of the first stopper 251 is protrusive beyond the first through hole 254 at the first inner side 216.

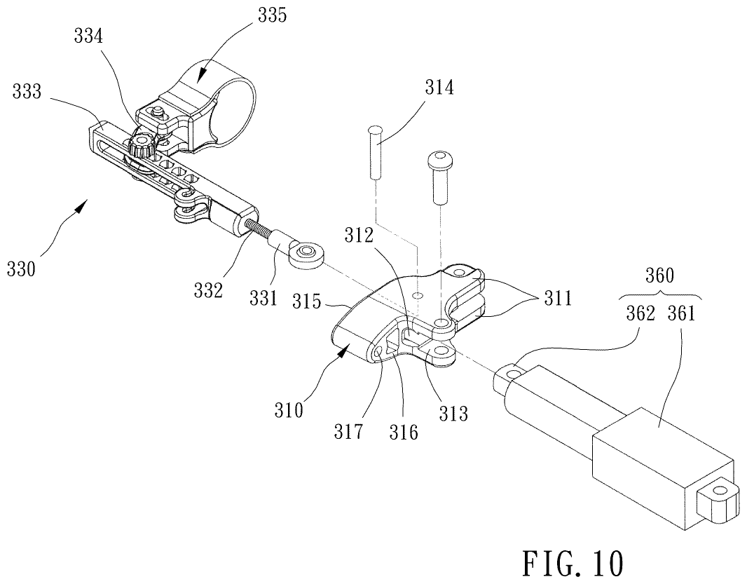

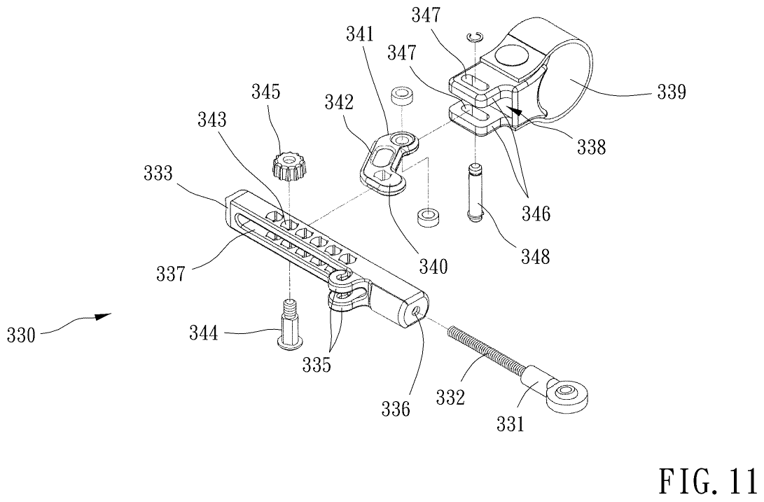

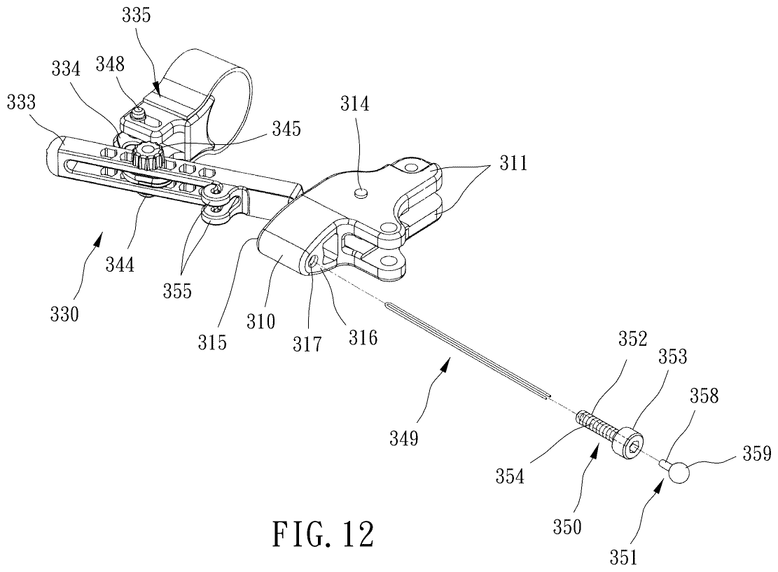

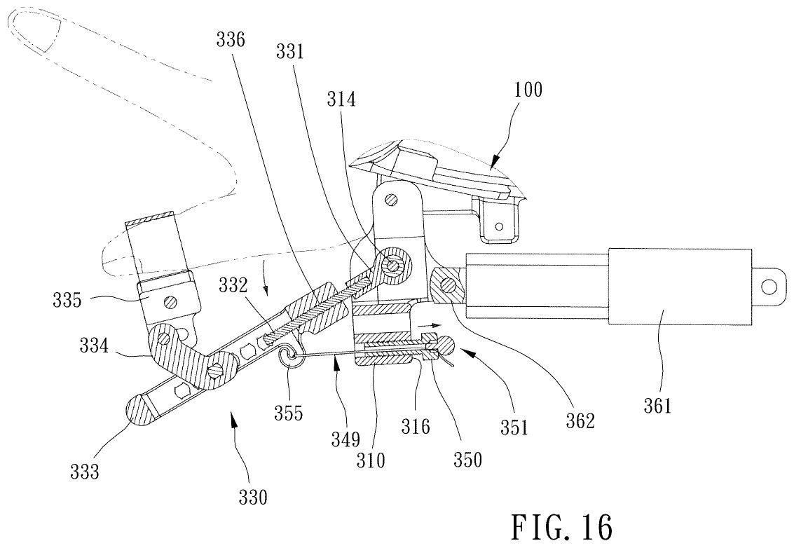

Please refer to FIGS. 10-12 and 16, the second linkage mechanism 330 is generally similar to the first linkage mechanism 230 in structure, function and effect.

The second linkage mechanism 330 includes a second joint support 331, a second threaded rod 332, a second rear rod 333, a second fore rod 334 and a second sleeving member 335. Two ends of the second threaded rod 332 are respectively screwed with the second joint support 331 and a second threaded hole 336 of the second rear rod 333. Two ends of the second fore rod 334 are movably connected respectively with a second rear elongated slot 337 of the second rear rod 333 and a second assembling slot 338 of the second sleeving member 335. The second sleeving member 335 includes a second strap 339, and the second strap 339 is preferably an elastic band which is easy and comfortable in use. The second linkage mechanism 330 is rotatably connected with a second shaft 314 by the second joint support 331 so as to be located within the second actuator slot 312, which provides a limited lateral swinging range for obtaining lateral adjustment of the second linkage mechanism 330 after wearing, and thus it provides additional lateral rehabilitation movement of the thumb. The second fore rod 334 includes a second upper bent section 340, a second lower bent section 341 and a second middle section 342, two ends of the second middle section 342 are integrally connected with the second upper bent section 340 and the second lower bent section 341. The second rear rod 333 includes a plurality of second adjustment holes 343 arranged along the second rear elongated slot 337 and through the second rear elongated slot 337, a second upper shaft 344 is movably disposed through the second upper bent section 340 and one of the plurality of second adjustment holes 343, and the second upper shaft 344 is secured to the second rear rod 333 by a second securing member 345. The second sleeving member 335 includes two second projections 346, the second assembling slot 338 is located between the two second projections 346, each of the two second projections 346 includes a second sliding groove 347, a second lower shaft 348 is movably disposed through the second sliding groove 347 and the second lower bent section 341 so that the second sleeving member 335 is movable with the second lower shaft 348 being movable along the second sliding groove 347.

The thumb frame 310 further includes a second outer side 315 and a second inner side 316 opposite to the second outer side 315, the thumb frame 310 further includes a thumb frame threaded hole 317 corresponding to the second linkage mechanism 330, and the thumb frame threaded hole 317 is disposed through the second outer side 315 and the second inner side 316. The second linkage mechanism 330 further includes a second rope 349, a second bolt 350 and a second stopper 351. The second bolt 350 includes a second rotation section 352 and a second driving section 353, the second bolt 350 further includes a second through hole 354 disposed through the second rotation section 352 and the second driving section 353, the second bolt 350 is screwed with the thumb frame threaded hole 317 by the second rotation section 352, and the second driving section 353 is protrusive beyond the thumb frame threaded hole 317 and located at the second inner side 316. A portion of the second rope 349 which is disposed through the second through hole 354 and hooked within at least one second hook portion 355 of the second rear rod 333 is defined as a second tension section 356, and another portion of the second rope 349 which is protrusive beyond the second through hole 354 is defined as a second free section 357. A second plug portion 358 of the second stopper 351 urges the second rope 349 and blocks the second rope 349 from detaching from the second through hole 354, and a second enlarged portion 359 of the second stopper 351 is protrusive beyond the second through hole 354 at and second inner side 316.

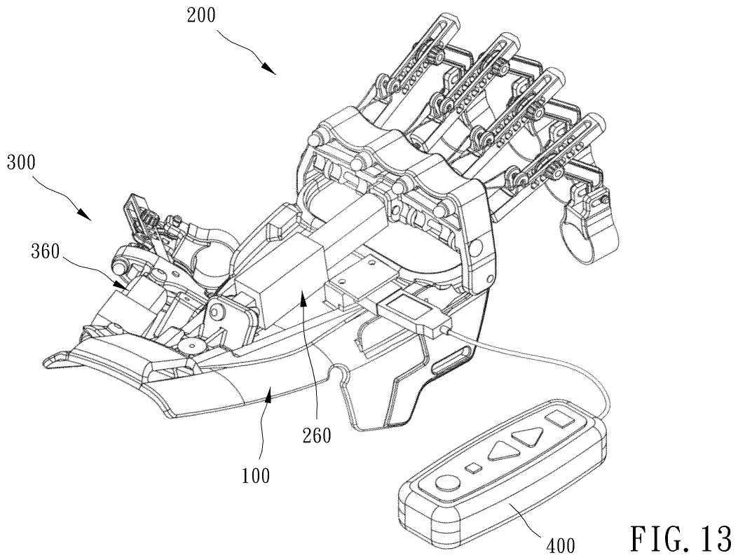

Please refer to FIG. 13, the rehabilitation device further includes an external control device 400 electrically connected with the first actuator 260 and the second actuator 360, wherein the external control device is configured to control the first actuator 260 and the second actuator 360 to move between the extended position and the retracted position. The external control device 400, the first actuator 260 and the second actuator 360 can be supplied with power externally or supplied with power form a battery disposed thereinside. The external control device 400 may include a plurality of control buttons configured to control either of the finger sleeve assembly 200 and the thumb sleeve assembly 300 to perform one-time, one-way or regular rehabilitation of the finger joints.

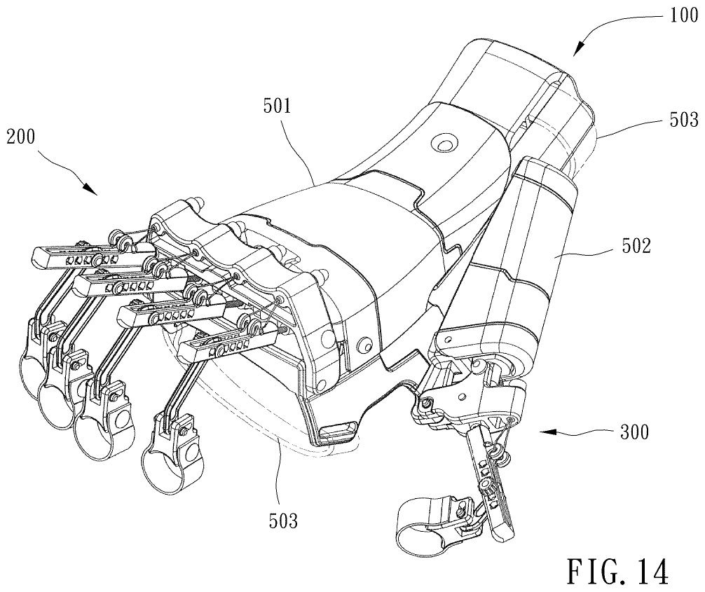

Please refer to FIG. 14, a first cover 501, a second cover 502 and fastening strap 503 are attached to the base 100, the first cover 501 shields most part of the first actuator 260 and a part of the base 100, and the second cover 502 shields most part of the second actuator 360 and a part of the base 100. The fastening strap 503 extends between two sides of the base 100, and the fastening strap 503 is configured to be fastened on the palm or/and the forearm so that the bottom portion of the base 100 can be abutted against the palm or/and the forearm.

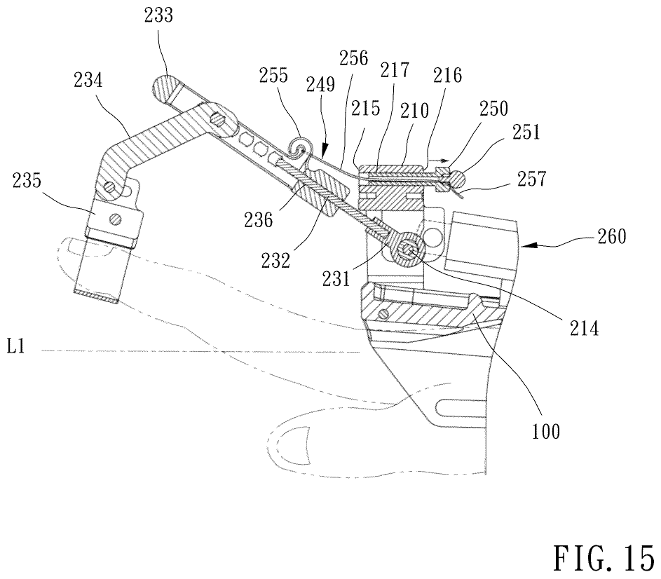

When the first bolt 250 is rotated to move in a direction from the first outer side 215 toward the first inner side 216 (as shown in FIG. 15), the first bolt 250 pulls the first rope 249 to move toward the first inner side 216 so that the first linkage mechanism 230 rotates about the first shaft 214 and the first linkage mechanism 230 is driven by the first rope 249 to swing upward relative to the finger frame 210. Whereby, the first linkage mechanism 230 can swing upward to the upper swing position to perform large range of rehabilitation movement so that the fingers can be bent upward over the horizontal plane, and thus the rehabilitation device can help user's fingers to exercise with large-ranged movement and has effective rehabilitation. Thumb sleeve assembly 300 is similar to the finger sleeve assembly 200 in operation described above (as shown in FIG. 15).

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A rehabilitation device, including a base, a finger sleeve assembly and a thumb sleeve assembly;
wherein the finger sleeve assembly includes a finger frame, a plurality of first linkage mechanisms and a first actuator, the first actuator includes a first motor and a first driving shaft, the first driving shaft is connected to the first motor, the first motor is configured to drive the first driving shaft to move axially relative to the first motor, the finger frame is rotatably connected to the base by two first ear portions, the finger frame includes a plurality of first linkage slots within which the plurality of first linkage mechanisms are respectively disposed, the first motor is rotatably connected to the base, the first driving shaft is rotatably connected to a first actuator slot of the finger frame, the first actuator is movable between a first extended position and a first retracted position to drive the finger frame to pivot between a lower swing position and an upper swing position relative to the base so that the plurality of first linkage mechanisms are swingable with the finger frame;
wherein the thumb sleeve assembly includes a thumb frame, a second linkage mechanism and a second actuator, the second actuator includes a second motor and a second driving shaft, the second driving shaft is connected to the second motor, the second motor is configured to drive the second driving shaft to move axially relative to the second motor, the thumb frame is rotatably connected to the base by two second ear portions, the thumb frame includes a second linkage slot within which the second linkage mechanism is disposed, the second motor is rotatably connected to the base, the second driving shaft is rotatably connected to a second actuator slot of the thumb frame, the second actuator is movable between a second extended position and a second retracted position to drive the thumb frame to pivot between an inward swing position and an outward swing position relative to the base so that the second linkage mechanism is swingable with the thumb frame;
wherein each of the plurality of first linkage mechanisms includes a first joint support, a first threaded rod, a first rear rod, a first fore rod and a first sleeving member; two ends of the first threaded rod are respectively screwed with the first joint support and a first threaded hole of the first rear rod; two ends of the first fore rod are movably connected respectively with a first rear elongated slot of the first rear rod and a first assembling slot of the first sleeving member; the first sleeving member includes a first strap; each of the plurality of first linkage mechanisms is rotatably connected with a first shaft by the first joint support so as to be located within one of the plurality of first linkage slots.

2. The rehabilitation device of claim 1, wherein the first fore rod includes a first upper bent section, a first lower bent section and a first middle section, two ends of the first middle section are integrally connected with the first upper bent section and the first lower bent section; the first rear rod includes a plurality of first adjustment holes which are non-circular and are arranged along the first rear elongated slot and through the first rear elongated slot, a first upper shaft which is non-circular is non-rotatably disposed through the first upper bent section and one of the plurality of first adjustment holes, and a first securing member which is a nut is screwed to an end of the first upper shaft to connect the first rear rod and the first upper bent section; the first sleeving member includes two first projections, the first assembling slot is located between the two first projections, each of the two first projections includes a first sliding groove, a first lower shaft is movably disposed through the first sliding groove and the first lower bent section so that the first sleeving member is movable with the first lower shaft being movable along the first sliding groove.

3. The rehabilitation device of claim 2, wherein the finger frame further includes a first outer side and a first inner side opposite to the first outer side, the finger frame further includes a plurality of finger frame threaded holes respectively corresponding to the plurality of first linkage mechanisms, the plurality of finger frame threaded holes are disposed through the first outer side and the first inner side; each of the plurality of first linkage mechanisms further includes a first rope, a first bolt and a first stopper; the first bolt includes a first rotation section and a first driving section, the first bolt further includes a first through hole disposed through the first rotation section and the first driving section, the first bolt is screwed with the finger frame threaded hole by the first rotation section, the first driving section is protrusive beyond the finger frame threaded hole and located at the first inner side; a portion of the first rope which is disposed through the first through hole and hooked within at least one first hook portion of the first rear rod is defined as a first tension section, another portion of the first rope which is protrusive beyond the first through hole is defined as a first free section; a first plug portion of the first stopper urges the first rope and blocks the first rope from detaching from the first through hole, a first enlarged portion of the first stopper is protrusive beyond the first through hole at the first inner side.

4. A rehabilitation device, including a base, a finger sleeve assembly and a thumb sleeve assembly;
wherein the finger sleeve assembly includes a finger frame, a plurality of first linkage mechanisms and a first actuator, the first actuator includes a first motor and a first driving shaft, the first driving shaft is connected to the first motor, the first motor is configured to drive the first driving shaft to move axially relative to the first motor, the finger frame is rotatably connected to the base by two first ear portions, the finger frame includes a plurality of first linkage slots within which the plurality of first linkage mechanisms are respectively disposed, the first motor is rotatably connected to the base, the first driving shaft is rotatably connected to a first actuator slot of the finger frame, the first actuator is movable between a first extended position and a first retracted position to drive the finger frame to pivot between a lower swing position and an upper swing position relative to the base so that the plurality of first linkage mechanisms are swingable with the finger frame;
wherein the thumb sleeve assembly includes a thumb frame, a second linkage mechanism and a second actuator, the second actuator includes a second motor and a second driving shaft, the second driving shaft is connected to the second motor, the second motor is configured to drive the second driving shaft to move axially relative to the second motor, the thumb frame is rotatably connected to the base by two second ear portions, the thumb frame includes a second linkage slot within which the second linkage mechanism is disposed, the second motor is rotatably connected to the base, the second driving shaft is rotatably connected to a second actuator slot of the thumb frame, the second actuator is movable between a second extended position and a second retracted position to drive the thumb frame to pivot between an inward swing position and an outward swing position relative to the base so that the second linkage mechanism is swingable with the thumb frame;
wherein the second linkage mechanism includes a second joint support, a second threaded rod, a second rear rod, a second fore rod and a second sleeving member; two ends of the second threaded rod are respectively screwed with the second joint support and a second threaded hole of the second rear rod; two ends of the second fore rod are movably connected respectively with a second rear elongated slot of the second rear rod and a second assembling slot of the second sleeving member; the second sleeving member includes a second strap; the second linkage mechanism is rotatably connected with a second shaft by the second joint support so as to be located within the second actuator slot.

5. The rehabilitation device of claim 4, wherein the second fore rod includes a second upper bent section, a second lower bent section and a second middle section, two ends of the second middle section are integrally connected with the second upper bent section and the second lower bent section; the second rear rod includes a plurality of second adjustment holes which are non-circular and are arranged along the second rear elongated slot and through the second rear elongated slot, a second upper shaft which is non-circular is non-rotatably disposed through the second upper bent section and one of the plurality of second adjustment holes, and a second securing member which is a nut is screwed to an end of the second upper shaft to connect the second rear rod and the second upper bent section; the second sleeving member includes two second projections, the second assembling slot is located between the two second projections, each of the two second projections includes a second sliding groove, a second lower shaft is movably disposed through the second sliding groove and the second lower bent section so that the second sleeving member is movable with the second lower shaft being movable along the second sliding groove.

6. The rehabilitation device of claim 5, wherein the thumb frame further includes a second outer side and a second inner side opposite to the second outer side, the thumb frame further includes a thumb frame threaded hole corresponding to the second linkage mechanism, the thumb frame threaded hole is disposed through the second outer side and the second inner side; the second linkage mechanism further includes a second rope, a second bolt and a second stopper; the second bolt includes a second rotation section and a second driving section, the second bolt further includes a second through hole disposed through the second rotation section and the second driving section, the second bolt is screwed with the thumb frame threaded hole by the second rotation section, the second driving section is protrusive beyond the thumb frame threaded hole and located at the second inner side; a portion of the second rope which is disposed through the second through hole and hooked within at least one second hook portion of the second rear rod is defined as a second tension section, another portion of the second rope which is protrusive beyond the second through hole is defined as a second free section; a second plug portion of the second stopper urges the second rope and blocks the second rope from detaching from the second through hole, a second enlarged portion of the second stopper is protrusive beyond the second through hole at the second inner side.

7. The rehabilitation device of claim 1, wherein further including an external control device electrically connected with the first actuator and the second actuator, wherein the external control device is configured to control the first actuator and the second actuator to move.
